(19) United States
(12) Patent Application Publication
(10) Pub. No.: US 2010/0259482 A1
(43) Pub. Date: Oct. 14, 2010

(54) KEYBOARD GESTURING

(75) Inventor: Vincent Ball, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/422,093

(22) Filed: Apr. 10, 2009

(51) Int. Cl. G06F 3/02; G06F 3/041

(52) U.S. Cl. 345/168; 345/173

(57) ABSTRACT

Keyboard gesturing on an input device of a computing system is herein provided. One exemplary computing system includes a host computing device and an input device including one or more keys. The host computing device includes a gesture-recognition engine that is configured to recognize a gesture from touch input reported from a touch-detection engine. The touch-detection engine is configured to detect a touch input directed at a key of the input device. The host computing device further includes an input engine that is configured to interpret a key-activation message based on the gesture recognized by the gesture-recognition engine, where the key-activation message is generated by a key-activation engine of the input device in response to activation of the key.

### BACKGROUND

Computing systems can be used for work, play, and everything in between. To increase productivity and improve the user experience, attempts have been made to design input devices that offer the user an intuitive and powerful mechanism for issuing commands and/or inputting data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Keyboard gesturing on an input device of a computing system is herein provided. One exemplary input device includes one or more keys that detect touch input. The computing system can recognize the detected touch input as gestures and interpret a key-activation message resulting from actuation of a key in accordance with recognized gestures pertaining to that key. In some embodiments, the input device may adaptively display a different key image on a key in response to a recognized gesture pertaining to that key.

### BRIEF DESCRIPTION OF THE DRAWINGS

FIG. 1A illustrates a computing system including an adaptive input device in accordance with an embodiment of the present disclosure.

FIG. 1B illustrates dynamic updates to the visual appearance of the adaptive input device of FIG. 1A.

FIG. 2 is a sectional view of an adaptive keyboard.

FIG. 3 shows a flow diagram of an embodiment of a method of dynamically configuring an adaptive input device based on touch gestures.

FIG. 4 schematically shows an embodiment of a computing system configured to detect touch gestures on an adaptive input device.

FIG. 5 schematically shows an embodiment of an adaptive input device.

FIG. 6 schematically shows an exemplary touch gesture on an input device.

FIG. 7 schematically shows another exemplary touch gesture on an input device.

FIG. 8 shows a block diagram of an embodiment of a computing system.

### DETAILED DESCRIPTION

The present disclosure is related to an input device that can provide input to a variety of different computing systems. The input device may include one or more physical or virtual controls that a user can activate to effectuate a desired user input. In some cases, the input device may be an adaptive input device, capable of dynamically changing its visual appearance to facilitate user input. As a non-limiting example, the adaptive input device may dynamically change the appearance of one or more buttons. The visual appearance of the adaptive input device may be dynamically changed according to user preferences, application scenarios, system scenarios, etc., as described in more detail below.

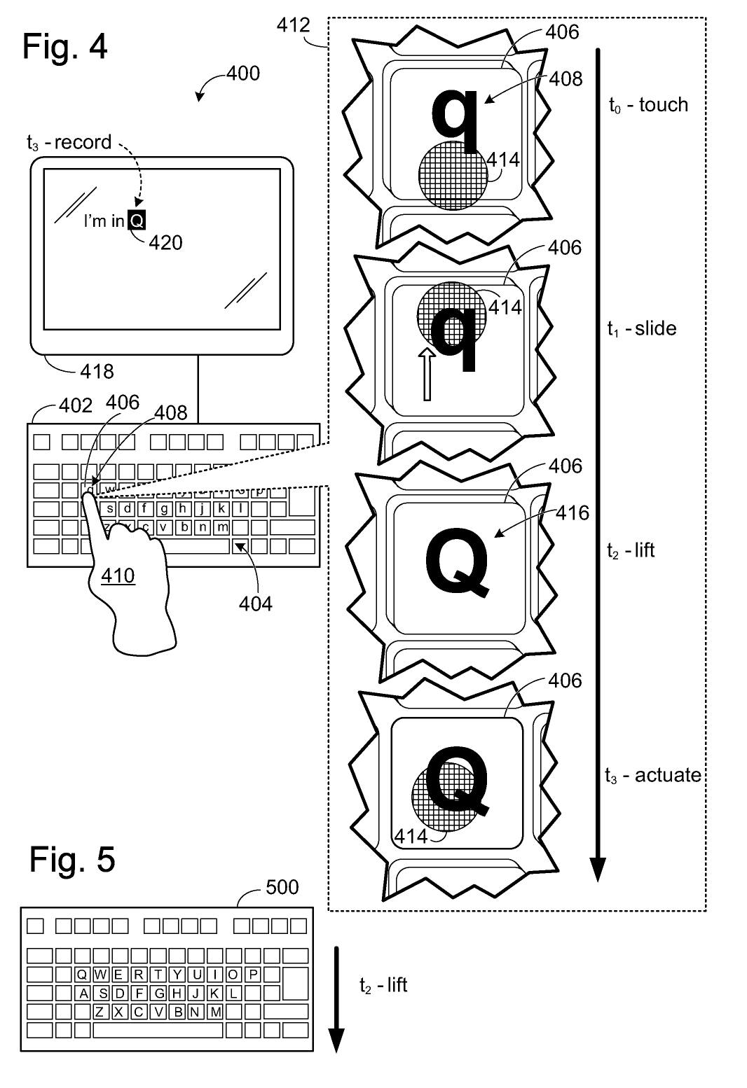

As explained in more detail below with reference to FIGS. 4-7, an input device may be touch-sensitive and therefore configured to detect touch inputs on the input device. Such an input device may be further configured to recognize touch gestures and select one or more settings (e.g. underline formatting) based on the recognized gestures. In the case of an adaptive input device, such an input device may be further configured to change the visual appearance of the input device based on the recognized gesture.

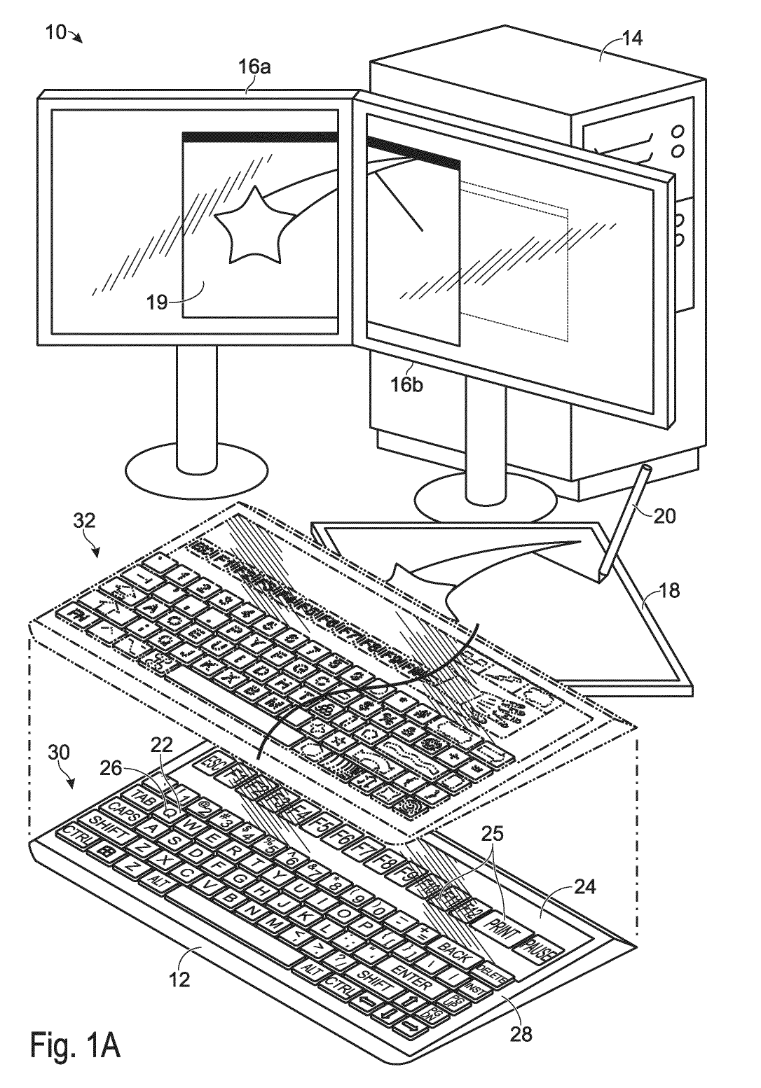

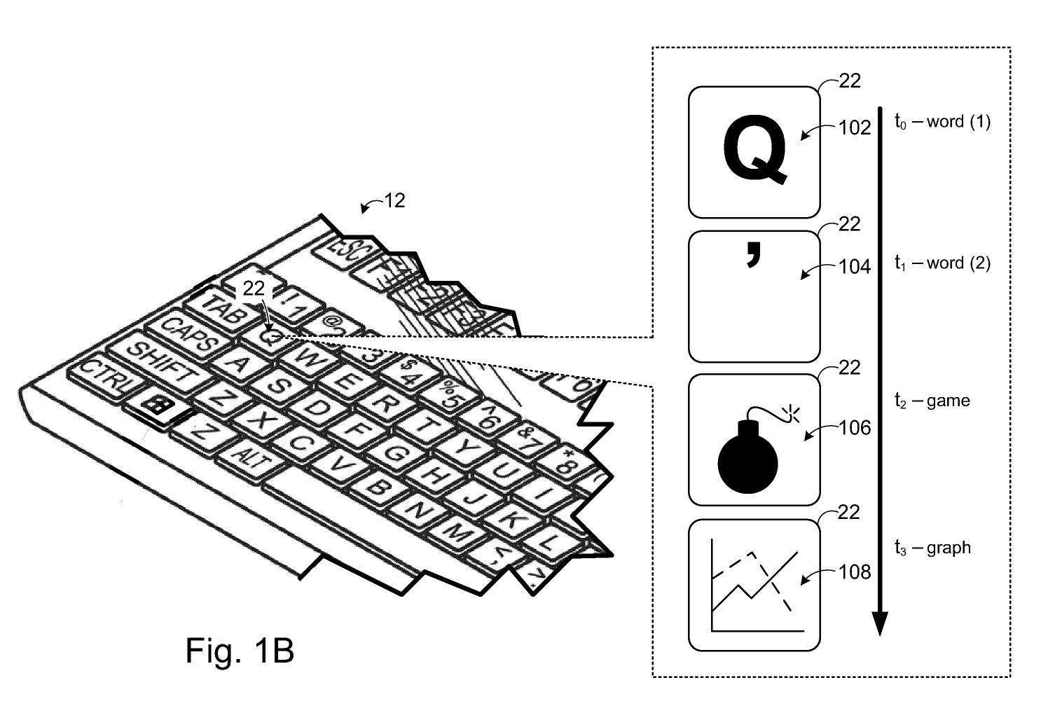

FIG. 1A shows a non-limiting example of a computing system 10 including an adaptive input device 12, such as an adaptive keyboard, with a dynamically changing appearance. The adaptive input device 12 is shown connected to a computing device 14. The computing device may be configured to process input received from adaptive input device 12. The computing device may also be configured to dynamically change an appearance of the adaptive input device 12.

Computing system 10 further includes monitor 16a and monitor 16b. While computing system 10 is shown including two monitors, it is to be understood that computing systems including fewer or more monitors are within the scope of this disclosure. The monitor(s) may be used to visually present visual information to a user.

Computing system 10 may further include a peripheral input device 18 receiving user input via a stylus 20 in this example. Computing device 14 may process an input received from the peripheral input device 18 and display a corresponding visual output 19 on the monitor(s). While a drawing tablet is shown as an exemplary peripheral input device, it is to be understood that the present disclosure is compatible with virtually any type of peripheral input device (e.g., keyboard, number pad, mouse, track pad, trackball, etc.).

In the illustrated embodiment, adaptive input device 12 includes a plurality of depressible keys (e.g., depressible buttons), such as depressible key 22, and touch regions, such as touch region 24 for displaying virtual controls 25. The adaptive input device may be configured to recognize when a key is pressed or otherwise activated. The adaptive input device may also be configured to recognize touch input directed to a portion of touch region 24. In this way, the adaptive input device may recognize user input.

Each of the depressible keys (e.g., depressible key 22) may have a dynamically changeable visual appearance. In particular, a key image 26 may be presented on a key, and such a key image may be adaptively updated. A key image may be changed to visually signal a changing functionality of the key, for example.

Similarly, the touch region 24 may have a dynamically changeable visual appearance. In particular, various types of touch images may be presented by the touch region, and such touch images may be adaptively updated. As an example, the touch region may be used to visually present one or more different touch images that serve as virtual controls (e.g., virtual buttons, virtual dials, virtual sliders, etc.), each of which may be activated responsive to a touch input directed to that touch image. The number, size, shape, color, and/or other aspects of the touch images can be changed to visually signal changing functionality of the virtual controls. It may be appreciated that one or more depressible keys may include touch regions, as discussed in more detail below.

The adaptive keyboard may also present a background image 28 in an area that is not occupied by key images or touch images. The visual appearance of the background image 28 also may be dynamically updated. The visual appearance of the background may be set to create a desired contrast with the key images and/or the touch images, to create a desired ambiance, to signal a mode of operation, or for virtually any other purpose.

By adjusting one or more of the key images, such as key image 26, the touch images, and/or the background image 28, the visual appearance of the adaptive input device 12 may be dynamically adjusted and customized. As nonlimiting examples, FIG. 1A shows adaptive input device 12 with a first visual appearance 30 in solid lines, and an example second visual appearance 32 of adaptive input device 12 in dashed lines.

The visual appearance of different regions of the adaptive input device 12 may be customized based on a large variety of parameters. As further elaborated with reference to FIG. 1B, these may include, but not be limited to: active applications, application context, system context, application state changes, system state changes, user settings, application settings, system settings, etc.

In one example, if a user selects a word processing application, the key images (e.g., key image 26) may be automatically updated to display a familiar QWERTY keyboard layout. Key images also may be automatically updated with icons, menu items, etc. from the selected application. For example, when using a word processing application, one or more key images may be used to present frequently used word processing operations such as “cut,” “paste,” “underline,” “bold,” etc. Furthermore, the touch region 24 may be automatically updated to display virtual controls tailored to controlling the word processing application. As an example, at t₀, FIG. 1B shows key 22 of adaptive input device 12 visually presenting a Q-image 102 of a QWERTY keyboard. At t₁, FIG. 1B shows the key 22 after it has dynamically changed to visually present an apostrophe-image 104 of a Dvorak keyboard in the same position that Q-image 102 was previously displayed.

In another example, if a user selects a gaming application, the depressible keys and/or touch region may be automatically updated to display frequently used gaming controls. For example, at t₂, FIG. 1B shows key 22 after it has dynamically changed to visually present a bomb-image 106.

As still another example, if a user selects a graphing application, the depressible keys and/or touch region may be automatically updated to display frequently used graphing controls. For example, at t₃, FIG. 1B shows key 22 after it has dynamically changed to visually present a line-plot-image 108.

As illustrated in FIG. 1B, the adaptive input device 12 dynamically changes to offer the user input options relevant to the task at hand. The entirety of the adaptive input device may be dynamically updated, and/or any subset of the adaptive input device may be dynamically updated. In other words, all of the depressible keys may be updated at the same time, each key may be updated independent of other depressible keys, or any configuration in between.

The user may, optionally, customize the visual appearance of the adaptive input device based on user preferences. For example, the user may adjust which key images and/or touch images are presented in different scenarios.

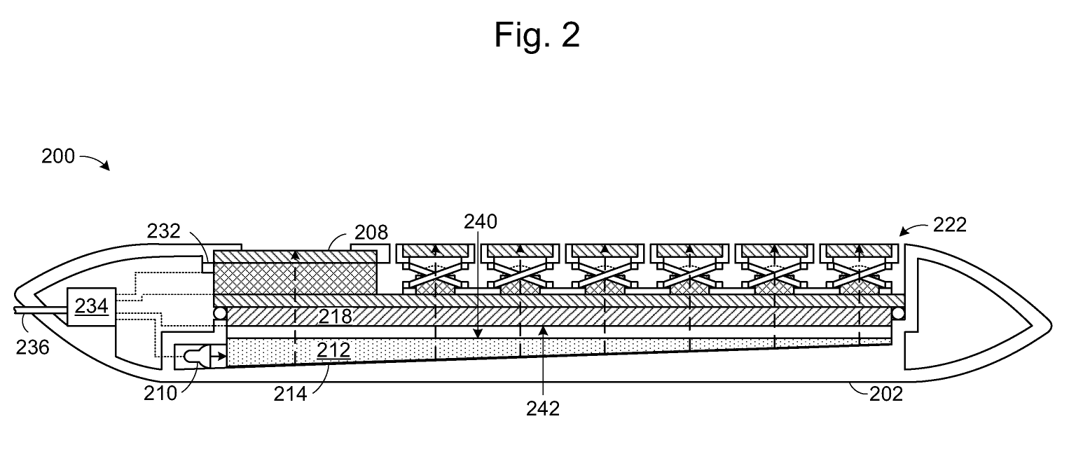

FIG. 2 is a sectional view of an example adaptive input device 200. The adaptive input device 200 may be a dynamic rear-projected adaptive keyboard in which images may be dynamically generated within the body 202 of adaptive input device 200 and selectively projected onto the plurality of depressible keys (e.g., depressible key 222) and/or touch regions (e.g., touch input display section 208).

A light source 210 may be disposed within body 202 of adaptive input device 200. A light delivery system 212 may be positioned optically between light source 210 and a liquid crystal display 218 to deliver light produced by light source 210 to liquid crystal display 218. In some embodiments, light delivery system 212 may include an optical waveguide in the form of an optical wedge with an exit surface 240. Light provided by light source 210 may be internally reflected within the optical waveguide. A reflective surface 214 may direct the light provided by light source 210, including the internally reflected light, through light exit surface 240 of the optical waveguide to a light input surface 242 of liquid crystal display 218.

The liquid crystal display 218 is configured to receive and dynamically modulate light produced by light source 210 to create a plurality of display images that are respectively projected onto the plurality of depressible keys, touch regions, or background areas (i.e., key images, touch images and/or background images).

The touch input display section 208 and/or the depressible keys (e.g., depressible key 222) may be configured to display images produced by liquid crystal display 218 and, optionally, to receive touch input from a user. The one or more display images may provide information to the user relating to control commands generated by touch input directed to touch input display section 208 and/or actuation of a depressible key (e.g., depressible key 222).

Touch input may be detected, for example, via capacitive or resistive methods, and conveyed to controller 234. It will be understood that, in other embodiments, other suitable touch-sensing mechanisms may be used, including vision-based mechanisms in which a camera receives an image of touch input display section 208 and/or images of the depressible keys via an optical waveguide. Such touch-sensing mechanisms may be applied to both touch regions and depressible keys, such that touch may be detected over one or more depressible keys in the absence of, or in addition to, mechanical actuation of the depressible keys.

The controller 234 may be configured to generate control commands based on the touch input signals received from touch input sensor 232 and/or key signals received via mechanical actuation of the one or more depressible keys. The control commands may be sent to a computing device via a data link 236 to control operation of the computing device. The data link 236 may be configured to provide wired and/or wireless communication with a computing device.

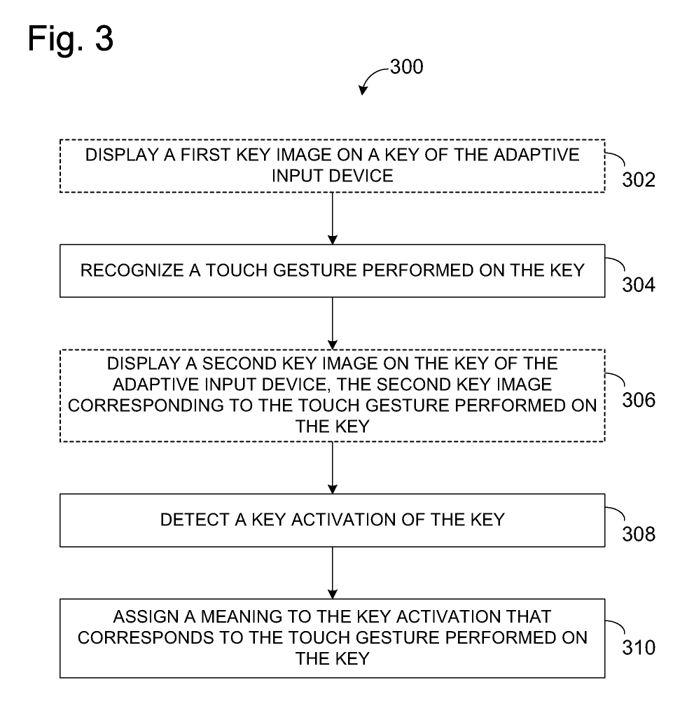

FIG. 3 shows an exemplary method 300 of dynamically configuring an adaptive input device based on touch gestures. Such a method may be performed by any suitable computing system, such as computing system 10 described above with reference to FIG. 1, and/or computing system 400 shown in FIG. 4. Using FIG. 4 as a nonlimiting example, computing system 400 may be configured to detect touch gestures on an adaptive input device such as adaptive input device 402. Adaptive input device 402 includes a plurality of keys 404, each key being touch-sensitive and therefore capable of detecting input touches. Keys 404 may be further configured to present a dynamically changeable visual appearance. Keys 404 may be depressible keys, such that each key may be activated by mechanical actuation of the key. In other cases, keys 404 may be non-depressible keys visually presented as part of a virtual touch-sensitive keyboard, where each key may be activated by a touch input, such as a finger tap. Adaptive input device 402 is exemplary, in that computing system 400 may alternatively include a touch-sensitive input device that is not configured to present a dynamically changeable visual appearance, as is described in more detail below.

Returning to FIG. 3, at 302 method 300 includes displaying a first key image on a key of the adaptive input device. As described above, key images may be used to display a familiar QWERTY keyboard layout, and/or images specific to applications such as icons, menu items, etc. As an example, FIG. 4 shows a key 406 displaying a key image 408 of the letter q.

Returning to FIG. 3, at 304 method 300 includes recognizing a touch gesture performed on the key. As nonlimiting examples, such touch gestures may include a sliding gesture, a holding gesture, etc. Touch gestures may be recognized in any suitable manner. For example, a computing system may include a touch-detection engine to detect a touch directed at a key. For example, the touch-detection engine may include a camera to detect touch input directed at the key. As another example, the touch-detection engine may include a capacitive sensor to detect touch input directed at the key. In the case of a virtual keyboard visually presenting the keys, such a capacitive sensor may be included within the display which is visually presenting the keys. Alternatively, in the case of a keyboard having keys that are not visually updateable, each key may include a capacitive sensor capable of detecting touch gestures. In some cases, the touch-detection engine may be configured to detect touch input directed at the key using resistive-based detection of the touch input and/or pressure sensing-based detection of the touch input.

Upon detecting the touch gesture, the touch gesture may be recognized by any suitable method. In some cases, a computing system may include a gesture-recognition engine configured to recognize a gesture from touch input reported from the touch-detection engine. Such a gesture-recognition engine may do so, for example, by determining to which of a plurality of known gestures the touch input corresponds. For example, such known gestures may include a swipe gesture, a flick gesture, a circular gesture, a finger tap, and the like. Further, in the case of a touch-sensitive input device configured to detect multi-touch gestures, such gestures may include a two-finger or three-finger swipe, tap, etc. Such multi-touch gestures may also include pinch gestures of two fingers (or a finger and thumb, etc.) moved towards each other in a “pinching” motion or away from each other in a reverse-pinching motion.

As an example, FIG. 4 shows a finger of a user 410 performing a touch gesture on key 406. Such a touch gesture is depicted in an expanded-view touch sequence 412. At time t₀, key 406 displays a first key image 408, and the finger of user 410 touches key 406, depicted in touch sequence 412 as a touch region 414 of the finger of user 410 overlapping a portion of the key 406. At time t₁, the finger of user 410 performs an upward touch gesture by sliding his finger upward on the key as indicated by the arrow. Accordingly, computing system 400 may detect the touch gesture to be a touch moving from the bottom of the key to the top of the key. Such detection may utilize, for example, a touch-detection engine as described above. Upon detecting the touch gesture, computing system 400 may recognize the touch moving from the bottom of the key to the top of the key as corresponding to an upward swipe gesture. Such recognition may utilize a gesture-recognition engine as described above.

Returning to FIG. 3, at 306 method 300 includes displaying a second key image on the key of the adaptive input device, where the second key image corresponds to the touch gesture performed on the key. As an example, at time t₂ FIG. 4 illustrates, upon determining that the recognized touch gesture corresponds to selecting a capitalization formatting, visually presenting a second key image 416 displaying a capital letter Q on key 406.

In some embodiments where key 406 is one of a plurality of keys, two or more of the plurality of keys may change key images responsive to recognition of a touch gesture on one of the plurality of keys. For example, time t₂ may also correspond to other keys of the adaptive input device presenting a second image. Such a case is shown for adaptive input device 500 in FIG. 5, where at time t₂ each of the QWERTY keys are updated to display a second image of a capitalized letter.

As described above, an input device may be configured to recognize such gestures whether or not the input device is adaptive. In other words, an input device may still recognize a touch gesture performed on a key, and change keystroke information based upon that touch gesture, even though it may not visually present an indication on the key of the change in keystroke information. In such a case, an embodiment of method 300 may begin at 304.

Returning to FIG. 3, at 308 method 300 includes detecting a key activation of the key. In the case of a depressible key, key activation (i.e., key actuation) may include mechanical actuation of the key. Alternatively, in the case of a non-depressible key, key activation may include a touch input such as a finger tap. In some cases, key activation may be triggered by the touch gesture itself, without further key actuations and/or tapping. Responsive to a key activation of the key, a key-activation message may be generated, for example, by a key-activation engine included within the input device or host computing device. In some cases, the key-activation message may be a generic message indicating that the key has been activated. In other cases, the key-activation message may further include information regarding the recognized touch gesture, as described in more detail below.

At 310, method 300 includes assigning a meaning to the key activation that corresponds to the touch gesture performed on the key. The assigned meaning may be virtually any meaning such as a formatting command, an editing command, a viewing command, etc. In some cases, a meaning may be assigned to the key activation upon receiving the key-activation message.

In some cases the meaning may be assigned by a host computing device. For example, a key-activation message indicating a key has been activated may be received from the input device by the host computing device. The host computing device, having determined that the recognized touch gesture corresponds to a particular meaning (e.g. a formatting command), may then assign this meaning to the key activation upon receiving the key-activation message.

Alternatively, a gesture meaning may be included as part of the key-activation message. As an example, a key activation triggered by the touch gesture may be independent of the key itself, in which case the key-activation message may indicate the gesture meaning. As another example, in the case of adaptive input device 402 shown in FIG. 4, time t₃ of touch sequence 412 corresponds to actuation of key 406 by a touch of the finger of user 410. Upon actuation, adaptive input device 402 may generate a key-activation message indicating that the key has been activated and that the key activation corresponds to capitalization formatting. Thus, whereas key 406 traditionally corresponds to selecting the letter “q,” the example shown in FIG. 4 depicts key 406 selecting “q” with an applied meaning of capitalization formatting, namely the selection of “Q.”

In other words, whereas a traditional keyboard may use font setting adjustments and/or the Shift or Caps Lock key to capitalize the “q” input selected by the q-key, the upward swipe gesture depicted in FIG. 4 has been used to select the capitalization formatting. Thus, a potential advantage of recognizing touch gestures on input devices may be using such touch gestures as a replacement for key commands. Moreover, due to the touch-sensitive nature of the keys, such touch gestures can be more intuitive than traditional key combinations, as described in more detail with reference to FIGS. 4-7.

It is to be understood that the touch gesture depicted in FIG. 4 is exemplary in that any of a variety of touch gestures corresponding to any of a variety of meanings may be utilized. For example, a touch gesture may be used to select other types of formatting such as bold or italics formatting, or a gesture may be used to select font type, size, color, etc., or other controllable aspects of an operating system or application.

In some cases, method 300 may further include recording and/or otherwise representing the key actuation. As an example, computing system 400 shown in FIG. 4 further includes a display 418. Thus, upon actuation at time t₃, computing system 400 records the user input and displays the letter Q, depicted at 420, on display 418. Such a recording may be, for example, in coordination with a word-processing application or the like.

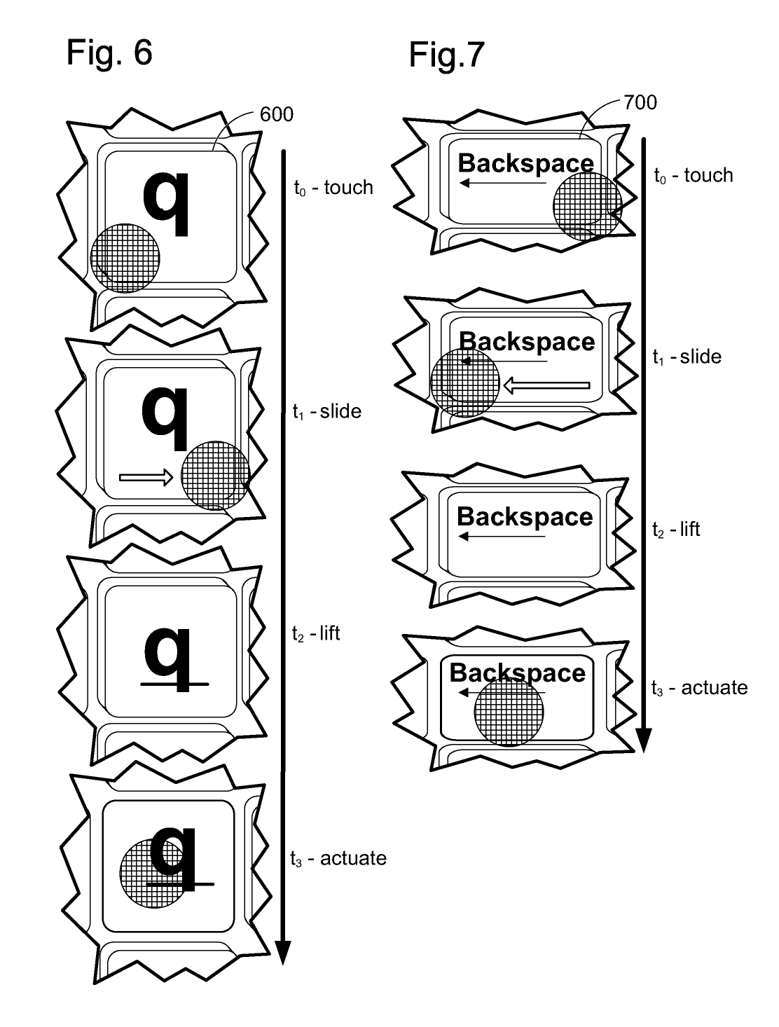

FIG. 6 shows another exemplary gesture of a slide in a rightward direction to assign an underline formatting meaning to the key activation. In such a case, the gesture begins at time t₀ with a finger touch on key 600. At time t₁, the touch gesture continues as the finger slides rightward. At time t₂, the finger touch lifts, and the rightward gesture is recognized as corresponding to selecting an underline formatting command. Upon recognizing the gesture, key 600 is updated to display an image indicating the selection of underlining. At time t₃, key 600 is actuated to select the underlined letter q, for example, when typing in a word-processing application.

FIG. 7 shows another exemplary gesture of a slide in a leftward direction on the backspace key. In such a case, the gesture begins at time t₀ with a finger touch on backspace key 700. At time t₁, the touch gesture continues as the finger slides leftward. At time t₂, the finger touch lifts, and the leftward gesture on the backspace key is recognized as corresponding to selecting a backspace editing command. Such a backspace editing command may correspond to, for example, selection of a preceding word or preceding sentence to be deleted upon actuation of the backspace key, whereas a traditional actuation of the backspace key deletes only one character. At time t₃, backspace key 700 is actuated to select the backspace editing command.

As described above, in some cases key activation may be triggered by the touch gesture. In such a case, a meaning assigned to the touch gesture may be independent of the key on which the touch gesture is performed. For example, the leftward swipe touch gesture depicted at times t₀, t₁ and t₂ of FIG. 7 may be performed, for example, on a key other than the backspace key. Such a touch gesture may trigger a backspace operation without the key being mechanically actuated and/or further gestured or tapped upon. This example illustrates another potential advantage of keyboard gesturing, in that touch gestures performed on a key may be independent of the key. Such operations may allow for more efficient data entry when a user is typing, since the user can perform editing, formatting, etc. from a current keyboard location while typing, and therefore may not have to search for specific keys.

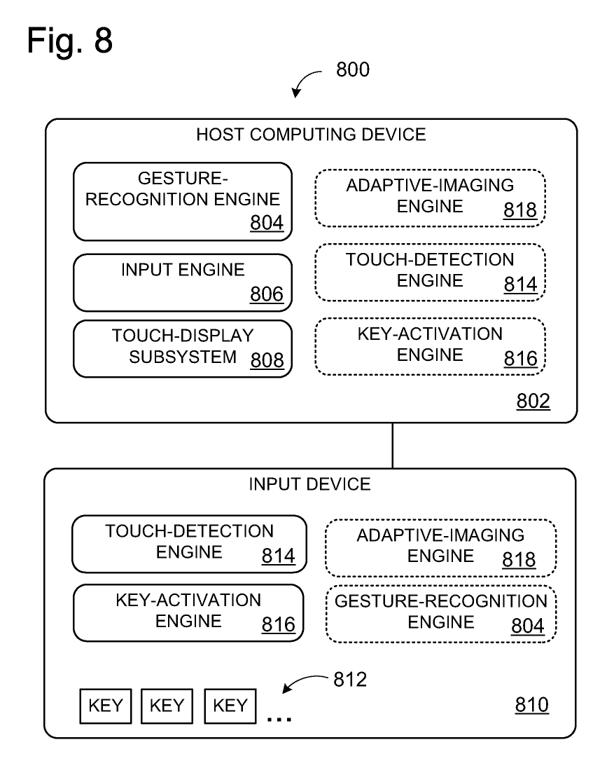

In some embodiments, the above described methods and processes may be tied to a computing system. As an example, FIG. 8 schematically shows a computing system 800 that may perform one or more of the above described methods and processes. Computing system 800 includes a host computing device 802 including a gesture-recognition engine 804 and an input engine 806. Computing system 800 may optionally include a touch-display subsystem 808 and/or other components not shown in FIG. 8. Computing system 800 further includes an input device 810 including one or more keys 812, a touch-detection engine 814, and a key-activation engine 816. In some embodiments of computing system 800, touch-detection engine 814 and/or key-activation engine 816 may be included within host computing device 802.

Touch-detection engine 814 may detect touch input directed at the key and report the touch input to the gesture-recognition engine 804 of the host computing device 802, such as described above with reference to FIG. 3. In some embodiments, gesture-recognition engine 804 may instead be included within input device 810, for example in the case of an adaptive input device configured to visually update images presented on the keys.

Upon activation of a key, key-activation engine 816 may generate a key-activation message, and input engine 806 of host computing device 802 may be configured to interpret the key-activation message based on the gesture recognized by the gesture-recognition engine 804, as described above with reference to FIGS. 3 and 4.

In some embodiments, host computing device 802 and/or input device 810 may further comprise an adaptive-imaging engine 818 to dynamically change a visual appearance of the key in accordance with rendering information received from the host computing device, such as the computing system and adaptive input device described above with reference to FIGS. 4 and 5. In such a case, the key-activation message may indicate a capitalization formatting command, a bold formatting command, an underline formatting command, a backspace editing command or virtually any other command.

In some cases, the adaptive-imaging engine 818 may change the visual appearance of the key responsive to recognition of a gesture by the gesture-recognition engine 804, where the visual appearance of the key changes to correspond to the gesture recognized by the gesture-recognition engine 804. Further, as described above with reference to FIG. 5, the adaptive-imaging engine 818 may be further configured to change the visual appearance of the one or more keys responsive to recognition of the gesture by the gesture-recognition engine 804.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a host computing device including a gesture-recognition engine and an input engine; and
an input device including:
one or more keys;
a touch-detection engine to detect a touch input directed at the key and report the touch input to the gesture-recognition engine of the host computing device; and
a key-activation engine to generate a key-activation message responsive to activation of the key:
the gesture-recognition engine of the host computing device configured to recognize a gesture from touch input reported from the touch-detection engine of the input device; and
the input engine of the host computing device configured to interpret the key-activation message based on the gesture recognized by the gesture-recognition engine.

2. The computing system of claim 1, further comprising an adaptive-imaging engine to dynamically change a visual appearance of the key in accordance with rendering information received from the host computing device.

3. The computing system of claim 2, where the adaptive-imaging engine changes the visual appearance of the key responsive to recognition of the gesture by the gesture-recognition engine, the visual appearance of the key changing to correspond to the gesture recognized by the gesture-recognition engine.

4. The computing system of claim 3, where the adaptive-imaging engine is further configured to change the visual appearance of the one or more keys responsive to recognition of the gesture by the gesture-recognition engine, the visual appearance of each of the keys changing to correspond to the gesture recognized by the gesture-recognition engine.

5. The computing system of claim 1, where the keys of the input device include one or more depressible keys and activation of the depressible keys includes mechanical actuation of the depressible keys.

6. The computing system of claim 1, where the gesture-recognition engine is configured to recognize the gesture by determining to which of a plurality of known gestures the touch input reported from the touch-detection engine corresponds.

7. The computing system of claim 1, where the touch-detection engine includes a camera to detect touch input directed at the key.

8. The computing system of claim 1, where the touch-detection engine includes a capacitive sensor to detect touch input directed at the key.

9. The computing system of claim 1, where the key-activation message indicates selection of a capitalization formatting command.

10. The computing system of claim 1, where the key-activation message indicates selection of a bold formatting command.

11. The computing system of claim 1, where the key-activation message indicates selection of an underline formatting command.

12. The computing system of claim 1, where the key-activation message indicates selection of a backspace editing command.

13. A method of dynamically configuring an adaptive input device based on touch gestures, comprising:
displaying a first key image on a key of the adaptive input device;
recognizing a touch gesture performed on the key;
displaying a second key image on the key of the adaptive input device, the second key image corresponding to the touch gesture performed on the key;
detecting a key activation of the key; and
assigning a meaning to the key activation that corresponds to the touch gesture performed on the key.

14. The method of claim 13, where assigning the meaning to the key activation includes assigning a capitalization formatting command to the key activation responsive to a recognized upward gesture performed on the key.

15. The method of claim 13, where assigning the meaning to the key activation includes assigning a bold formatting command to the key activation responsive to a recognized two-finger slide gesture performed on the key.

16. The method of claim 13, where assigning the meaning to the key activation includes assigning an underline formatting command to the key activation responsive to a recognized rightward gesture performed on the key.

17. The method of claim 13, where assigning a meaning to the key activation includes assigning a backspace editing command to the key activation responsive to a recognized leftward gesture performed on the key.

18. The method of claim 13, where the key is a one of a plurality of keys, and where two or more of the plurality of keys change key images responsive to recognition of the touch gesture on one of the plurality of keys.

19. An adaptive input device, comprising: one or more keys;
an adaptive-imaging engine to dynamically change a visual appearance of a key in accordance with rendering information received from a host computing device;
a touch-detection engine to detect touch input directed at the key;
a gesture-recognition engine to recognize a gesture from touch input detected by the touch-detection engine; and
a key-activation engine to generate a key-activation message responsive to activation of the key, the key-activation message corresponding to the gesture recognized by the gesture-recognition engine.

20. The adaptive input device of claim 19, where the adaptive-imaging engine changes the visual appearance of the key responsive to recognition of the gesture by the gesture-recognition engine, the visual appearance of the key changing to correspond to the gesture recognized by the gesture-recognition engine.
